(19) United States
(12) Patent Application Publication
(10) Pub. No.: US 2026/0052332 A1
(43) Pub. Date: Feb. 19, 2026

(54) PORTABLE SPEAKER MOUNT AND METHODS OF MAKING AND USING PORTABLE SPEAKER MOUNT

(71) Applicants: Kyle Patrick Smith, Warwick, GA (US); Jacob T. West, Leesburg, GA (US)

(72) Inventors: Kyle Patrick Smith, Warwick, GA (US); Jacob T. West, Leesburg, GA (US)

(21) Appl. No.: 19/301,783

(22) Filed: Aug. 15, 2025

Related U.S. Application Data
(60) Provisional application No. 63/683,431, filed on Aug. 15, 2024.

(51) Int. Cl. H04R 1/02; F16M 13/02

(52) U.S. Cl. CPC H04R 1/026; F16M 13/02; H04R 2201/025

(57) ABSTRACT

A portable speaker mount, according to various embodiments, comprises: a support plate defining a substantially planar surface and at least one malleable connector that may be moved between a first configuration in which the malleable connector has a first girth, and a second configuration in which the connector has a second girth that is larger than the first girth. The mount may comprise a rotatable member that may be used to move the malleable connector between the first and second configurations. For example, the malleable connector may include a malleable tube disposed on a threaded portion of a screw, and a nut positioned adjacent a distal end of the screw. When the screw is rotated clockwise, the nut moves toward a head of the screw and the malleable tube is thereby compressed lengthwise between the head and the nut, which causes the girth of the malleable tube to increase.

### CROSS REFERENCE TO RELATED APPLICATIONS

This application claims the benefit of U.S. Provisional Patent Application Ser. No. 63/683,431, filed Aug. 15, 2024, which is hereby incorporated herein by reference in its entirety.

### FIELD OF THE INVENTION

Various embodiments of the present invention relate to a PORTABLE SPEAKER MOUNT and methods of making and using PORTABLE SPEAKER MOUNT. Additional embodiments relate to mounts for other items and methods of making and using those mounts.

### BACKGROUND OF THE INVENTION

There is a need in the art for an improved PORTABLE SPEAKER MOUNT that enables a versatile mounting system for a popular portable speaker onto various surfaces and places including walls, watercraft, UTVs and ATVs, vehicles and many other places, and allows more versatility of this portable speaker with the PORTABLE SPEAKER MOUNT. This PORTABLE SPEAKER MOUNT design will not require bolts or screws to be removed from the portable speaker in order to be installed on the rear of the speaker.

### SUMMARY OF VARIOUS EMBODIMENTS

A PORTABLE SPEAKER MOUNT according to various embodiments comprises a backer plate and elastic or malleable holding pins to attach to the portable speaker it is designed to be used with. The PORTABLE SPEAKER MOUNT may comprise of this backer plate with elastic or rubber mounting mechanisms that are used to attach the PORTABLE SPEAKER MOUNT to the speaker itself without being screwed into existing threaded areas on the speaker and allows straps or universally available mounting systems to be attached to the PORTABLE SPEAKER MOUNT with its varying slots and hole patterns.

In some embodiments, the PORTABLE SPEAKER MOUNT comprises of rubber or malleable plastic pieces that when tightened by a screw or threaded rod act to compress in a way that causes the malleable part to expand outward on the sides and hold in a hole or slot and in turn allows the plate to be attached to speaker. This method of attaching should decrease the chance of the mounting system breaking the material that it is attached to since the malleable pieces will act as a cushion or shock absorber between the mounting plate and the object it is attached to.

A method for making a PORTABLE SPEAKER MOUNT, according to various embodiments, comprises: An aluminum plate being machined or CNC cut to the pattern that is needed to match the utilized hole pattern on the speaker and with additional slots or holes added that allow the plate and therefore the speaker to be mounted to other surfaces or points or other universally available mounting systems. The malleable part of the PORTABLE SPEAKER MOUNT can either be molded or manufactured with different additive manufacturing techniques.

In some embodiments, the method for making a PORTABLE SPEAKER MOUNT comprises: A molded or cast plate being made to the size and shape that is needed to match the utilized hole pattern on the speaker along with the additional slots and holes needed to allow for mounting the plate to other objects including some universally available mounting systems. This molded plate can be made out of varying materials. The malleable part of the PORTABLE SPEAKER MOUNT can either be molded or manufactured with different additive manufacturing techniques.

Particular embodiments are further directed to versatile means of mounting any object that may or may not have threaded mounting options available.

Various embodiments are even further directed to kits for making a PORTABLE SPEAKER MOUNT.

These and other features and advantages of various embodiments of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1A depicts an exemplary PORTABLE SPEAKER MOUNT according to a particular embodiment;

FIG. 1B depicts a rear view of the exemplary PORTABLE SPEAKER MOUNT shown in FIG. A;

FIG. 1C depicts a view of the malleable pieces used to attach the exemplary PORTABLE SPEAKER MOUNT shown in FIGS. 1A and 1B;

FIG. 2 is a perspective view of a PORTABLE SPEAKER MOUNT according to a further embodiment; and

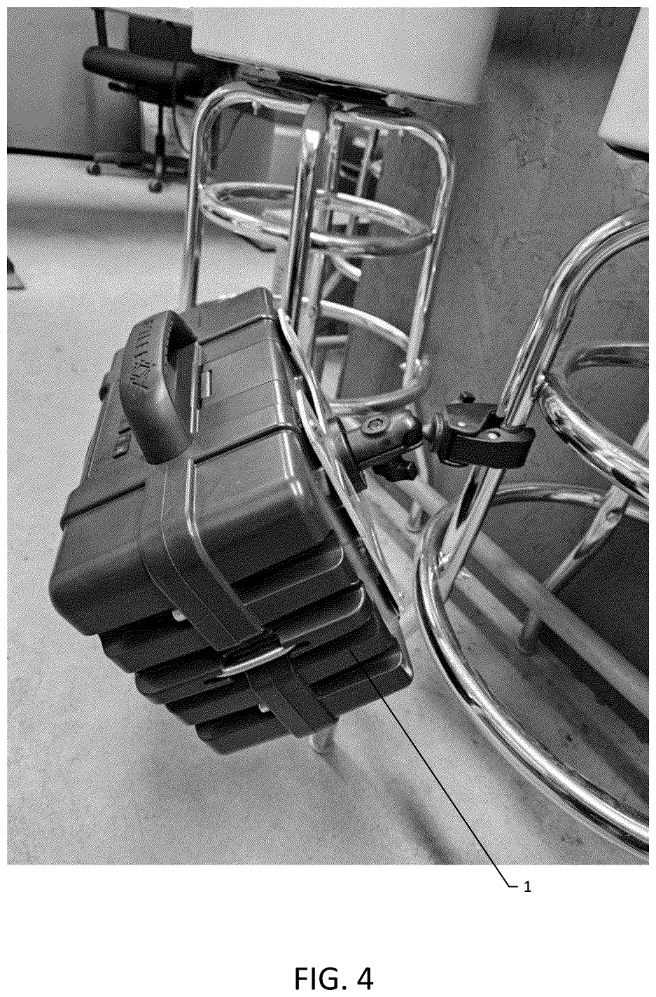

FIGS. 3-5 are additional perspective views of the PORTABLE SPEAKER MOUNT of FIG. 2.

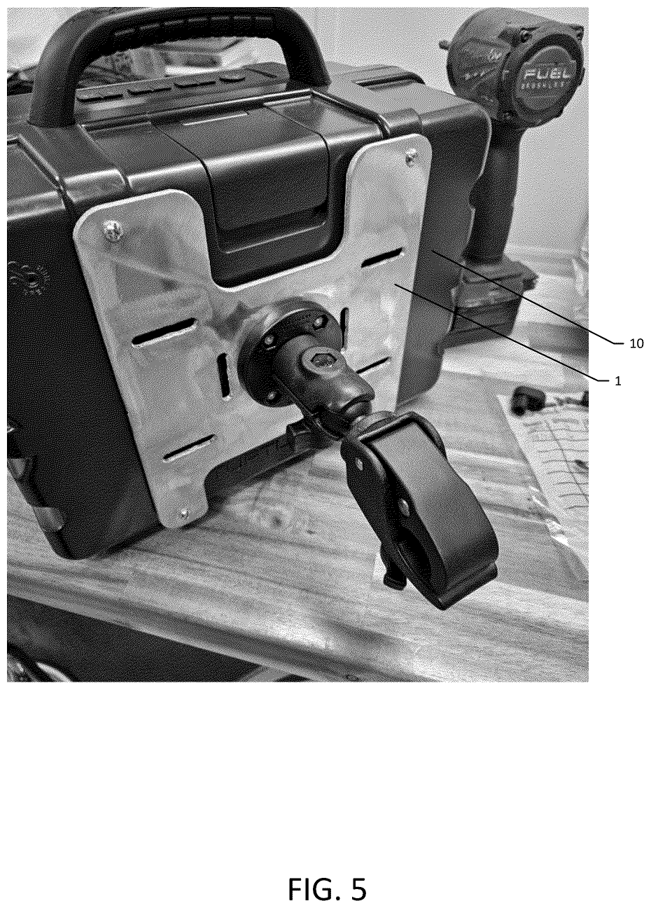

The features of various embodiments of the PORTABLE SPEAKER MOUNT, and methods are set forth in part in the following preferred embodiments. This overview is intended to provide nonlimiting descriptions of the present subject matter and is not intended to provide an exclusive or exhaustive explanation. The embodiments below provide further information about the PORTABLE SPEAKER MOUNT, and related methods as described herein.

### DETAILED DESCRIPTION OF THE INVENTION

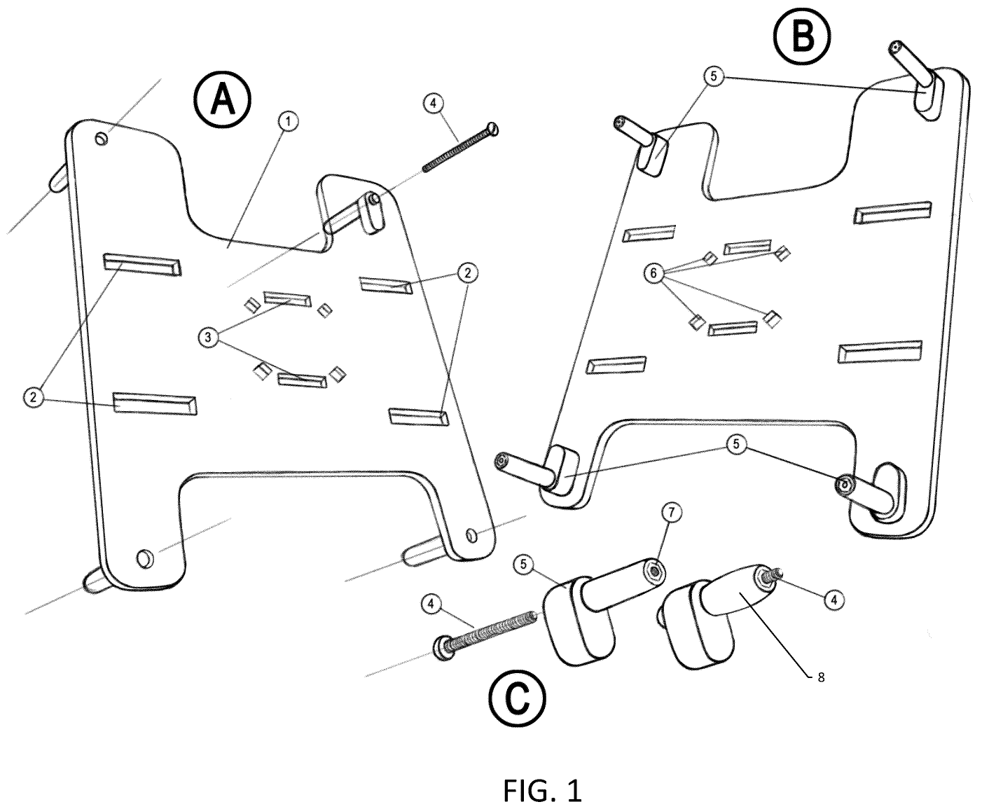

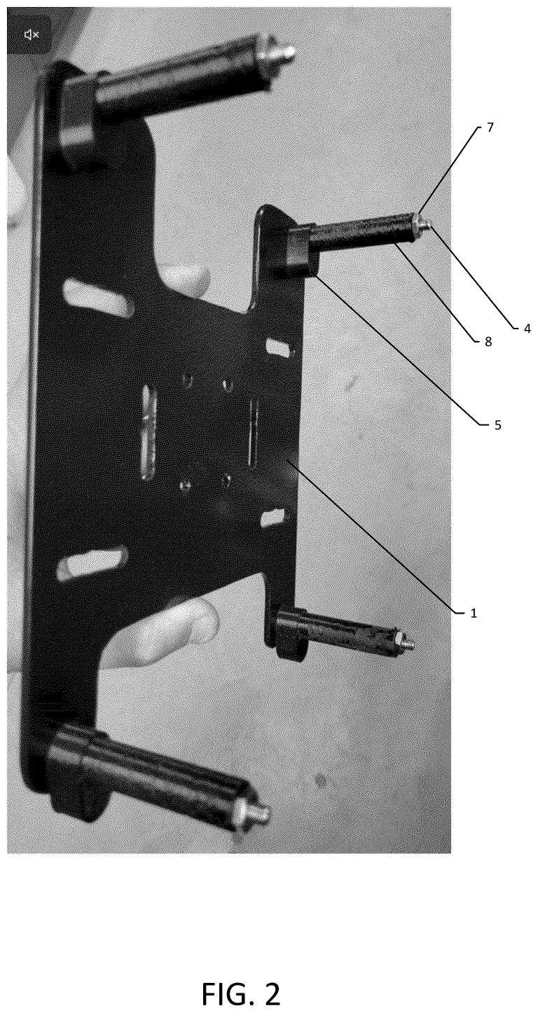

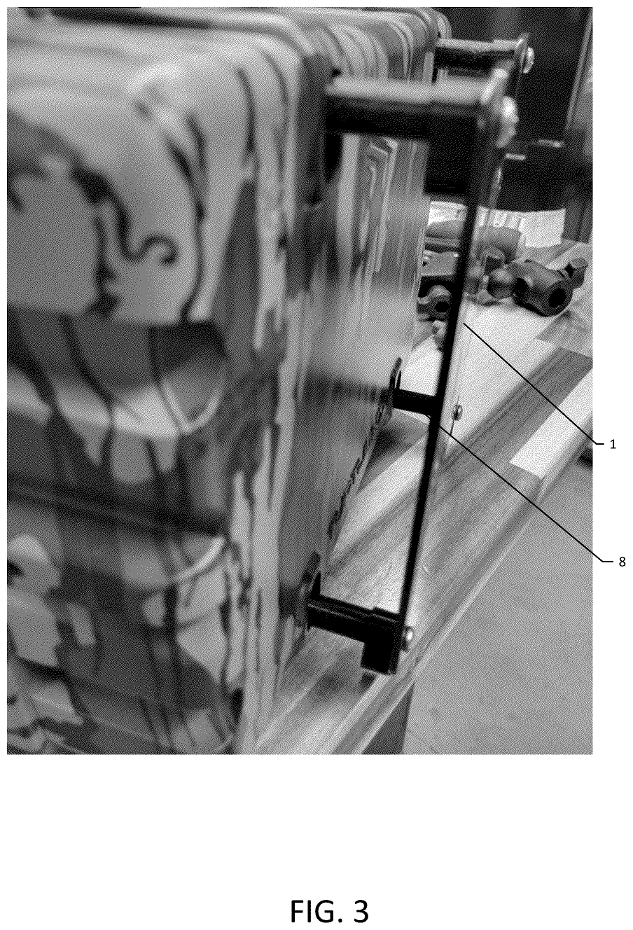

FIGS. 1A, 1B and IC provide examples of an exemplary PORTABLE SPEAKER MOUNT, and an exemplary method of attachment according to various embodiments.

The present invention is described above and further illustrated below by way of additional embodiments, and examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

Turning now to the drawings, in which like reference characters indicate corresponding elements throughout the several views, attention is first directed to FIG. 1A in which there is seen a frontside view of the mounting plate 1, this view also shows the strap slots 2 and 3 that will either be cut in or molded into the mounting plate 1 to allow the entire mounting plate 1 to be mounted via straps that go in and out of the any or all of the strap slots 2 and 3 and attached to any number of desired mounting surfaces. This view shown in FIG. 1A also shows how the mounting bolt or threaded rod 4 passes through the mounting plate 1 is threaded into the malleable pin or plug 5 shown in further detail in FIG. 1C on the other side of mounting plate 1 as shown in FIG. 1B.

Referring to FIG. 1B, in which the reverse side of mounting plate 1 in FIG. 1A is shown, you can clearly see how the malleable pin or plugs 5 are on the backside of the mounting plate 1. These pins or plugs 5 can either be free floating or could be attached to the side of the mounting plate 1 as shown in FIG. 1B. FIG. 1B also shows a universally accepted hole pattern 6 for mounting other means of attachment to the mounting plate 1. This universally standardized and accepted hole pattern 6 could be a cut or drilled or molded into the mounting plate 1 and it would allow for even more means of mounting the mounting plate 1 and therefore the item the mounting plate 1 is attached to other objects.

Attention is now directed to FIG. 1C, in which the malleable pins or plugs 5 are shown to have a threaded nut 7 on one end of the pin or plug 5. This threaded nut 7 can either be loose on the end of pin or plug 5 or could be molded into the pin or plug. This threaded nut 7 could also have a slot that is molded into the end of pin or plug 5 that effectively holds it and docs not allow it to fall out. FIG. 1C also illustrates what happens when the screw or threaded rod 4 is tightened into the pin or plug 5 by turning it into the threaded nut 7 on the opposite end. The screw 4 and nut 7 act to compress the pin or plug 5 causes it (e.g., its malleable body portion 8) to swell outward as it is tightened. It is therefore understood that this swelling of the pin or plug 5 will allow the pin or plug 5 to essentially grip the inside of a tube or cavity (e.g., defined by the back surface or other surface of a speaker 10 or other item) that it is designed to narrowly fit into when relaxed or untightened.

### Methods of Making Portable Speaker Mount Embodiments

A method for making a PORTABLE SPEAKER MOUNT according to various embodiments comprises: Cutting the pattern for the PORTABLE SPEAKER MOUNT with either a laser, plasma or waterjet out a sheet of steel or aluminum or plastic.

Another method for making the PORTABLE SPEAKER MOUNT would be to use additive manufacturing techniques such as 3d printing to make one or more components of the plate and/or the pins/plugs described in the detailed description.

Another method for making the PORTABLE SPEAKER MOUNT would be to use a plastic molding method to manufacture one or more components of the plate and/or the pins/plugs described in the detailed description.

### Methods of Using Portable Speaker Mount Embodiments

A method for enabling the attachment/removal of PORTABLE SPEAKER MOUNT to various surfaces could comprise simply running straps through the noted strap slots and securing it via a buckle or rachet to the other surface. It is intended for this to be useful for strapping to roll bars, poles, boards, wall panels, etc. A foam backer could be used between the PORTABLE SPEAKER MOUNT and the surface to help keep it from slipping or rotating around.

Another method for enabling the attachment/removal of the PORTABLE SPEAKER MOUNT to various surfaces could be to simply attach a readily available mount such as a those made by RAM industries or the like and use their system for mounting the PORTABLE SPEAKER MOUNT to the surface or item.

It should be understood that although the above-described PORTABLE SPEAKER MOUNT, and/or methods are described as “comprising” one or more components or steps, the above-described PORTABLE SPEAKER MOUNT, and/or methods may “comprise,” “consist of,” or “consist essentially of” any of the above-described components, features, or steps of the PORTABLE SPEAKER MOUNT, and/or methods. Consequently, where various embodiments, or a portion thereof, have been described with an open-ended term such as “comprising,” it should be readily understood that (unless otherwise stated) the description of the various embodiments, or the portion thereof, should also be interpreted to describe those various embodiments, or a portion thereof, using the terms “consisting essentially of” or “consisting of” or variations thereof as discussed below.

As used herein, the terms “comprises,” “comprising,” “includes,” “including,” “has,” “having,” “contains,” “containing,” “characterized by” or any other variation thereof, are intended to encompass a non-exclusive inclusion, subject to any limitation explicitly indicated otherwise, of the recited components. For example, a PORTABLE SPEAKER MOUNT, and/or method that “comprises” a list of elements (e.g., components, features, or steps) is not necessarily limited to only those elements (or components or steps) but may include other elements (or components or steps) not expressly listed or inherent to the PORTABLE SPEAKER MOUNT, and/or the method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a PORTABLE SPEAKER MOUNT, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of.”

Further, it should be understood that the herein-described PORTABLE SPEAKER MOUNT, and/or methods may comprise, consist essentially of, or consist of any of the herein-described components and features, with or without any additional feature(s). In other words, in some embodiments, the PORTABLE SPEAKER MOUNT, and/or methods of the present invention do not have any additional features other than those described herein, and such additional features, not described herein, are specifically excluded from the PORTABLE SPEAKER MOUNT, and/or methods. In other embodiments, the PORTABLE SPEAKER MOUNT, and/or methods of the present invention do have one or more additional features that are not described herein.

While the specification has been described in detail with respect to specific embodiments thereof, it will be appreciated that those skilled in the art, upon attaining an understanding of the foregoing, may readily conceive of alterations too, variations of, and equivalents to these embodiments. Accordingly, the scope of the present invention should be assessed as that of the appended claims and any equivalents thereto.

### Example Unique Aspects

Various embodiments are unique in that they allow for the attachment of a bracket or other item to be attached to any suitable item having a cavity that is dimensioned so that the malleable connector can frictionally engage the interior surface defining the cavity when the malleable connector expands. This may be done without having to deconstruct or take apart the item. Such suitable items may include, for example, audio equipment, lights, fans, industrial equipment, power tools or items being picked up by a robot (e.g., where the robot may selectively increase or decrease the girth of the malleable connector to selectively attach to or disconnect from particular items being picked up).

Particular embodiments may also have dampening or insulating abilities, for example if the mount is isolated from the item being supported by a rubber or other elastomeric material.

We claim:

1. A speaker mount comprising:
a support plate defining a substantially planar surface and at least one malleable connector extending outwardly from the surface, the malleable connector being adapted to be moved between:
(a) a first configuration in which the malleable connector has a first girth; and
(b) a second configuration in which the connector has a second girth that is larger than the first girth; and
a rotatable member that may be used to move the malleable connector between the first and second configurations.

2. The speaker mount of claim 1, wherein the malleable connector comprises:
a screw having a screw head and a threaded shaft extending outwardly from the screw head;
a malleable tube disposed on the threaded shaft, and
a nut disposed adjacent a distal end of the threaded shaft so that the malleable tube is positioned between the screw head and the nut, the nut having been rotatably threaded onto the threaded shaft.

3. The speaker mount of claim 2, wherein the malleable connector is configured so that, in response to the screw being rotated in a particular direction, the nut moves toward a head of the screw so that, as a result, the malleable tube is compressed lengthwise between the head and the nut, causing the girth of the malleable tube to increase.
